(19) United States
(12) Patent Application Publication
(10) Pub. No.: US 2026/0212227 A1
(43) Pub. Date: Jul. 23, 2026

(54) SCHEDULING MODEL INFERENCE REQUEST

(71) Applicant: BEIJING BAIDU NETCOM SCIENCE TECHNOLOGY CO., LTD., BEIJING (CN)

(72) Inventors: Honglin REN, BEIJING (CN); Mingren HU, BEIJING (CN); Zhengxiong YUAN, BEIJING (CN); Xin DAI, BEIJING (CN); Yongkang XIE, BEIJING (CN); Zhengyu QIAN, BEIJING (CN); En SHI, BEIJING (CN)

(73) Assignee: BEIJING BAIDU NETCOM SCIENCE TECHNOLOGY CO., LTD., BEIJING (CN)

(21) Appl. No.: 19/570,537

(22) Filed: Mar. 18, 2026

(30) Foreign Application Priority Data
Jun. 20, 2025 (CN) 202510838880.8

(51) Int. Cl. G06N 5/04; G06F 9/48

(52) U.S. Cl. CPC G06N 5/04; G06F 9/4881

(57) ABSTRACT

A scheduling method for a model inference request is provided. The implementation includes: determining, based on a model inference request to be scheduled, at least one first data item to be encoded; determining a cache hit rate corresponding to each model instance based on a first data index and the at least one first data item, where the first data index includes: a plurality of second data items determined by performing deduplication processing based on a plurality of historical data items cached by the plurality of model instances; and a data identifier corresponding to each second data item, which includes a plurality of sub-identifiers, each sub-identifier indicating whether the model instance corresponding to the sub-identifier caches the second data item; determining a target model instance based on the cache hit rate corresponding to each model instance; and scheduling the model inference request to the target model instance to perform inference.

### CROSS REFERENCE TO RELATED APPLICATION

This application claims priority to Chinese Patent Application No. 2025108388808, filed on June 20, 2025, the contents of which are hereby incorporated by reference in their entirety for all purposes.

### TECHNICAL FIELD

The present disclosure relates to the technical field of artificial intelligence, and in particular, to the technical field of large models and distributed model serving, and specifically to a scheduling method for a model inference request, an electronic device, a computer-readable storage medium.

### BACKGROUND

Artificial intelligence is a subject on making a computer simulate some thinking processes and intelligent behaviors (such as learning, reasoning, thinking, and planning) of a human, and involves both hardware-level technologies and software-level technologies. Artificial intelligence hardware technologies generally include technologies such as sensors, dedicated artificial intelligence chips, cloud computing, distributed storage, and big data processing. Artificial intelligence software technologies mainly include the following several general directions: computer vision technologies, speech recognition technologies, natural language processing technologies, machine learning/deep learning, big data processing technologies, and knowledge graph technologies.

In the field of large models, as the scale of model parameters and the context length increase, the computational power consumption increases significantly. By enabling a large model instance to cache intermediate encoding results of historical requests when processing inference requests, it is possible to reuse the intermediate encoding results cached by the large model instance as much as possible after receiving a new request, thereby saving the occupation of hardware resources by the encoding process and improving the efficiency of model inference.

Methods described in this section are not necessarily methods that have been previously conceived or employed. It should not be assumed that any of the methods described in this section is considered to be prior art just because they are included in this section, unless otherwise indicated expressly. Similarly, the problem mentioned in this section should not be considered to be universally recognized in any prior art, unless otherwise indicated expressly.

### SUMMARY

The present disclosure provides a scheduling method for model inference requests, an electronic device, a computer-readable storage medium.

According to an aspect of the present disclosure, a scheduling method for a model inference request is provided, including: determining, based on a model inference request to be scheduled, at least one first data item to be encoded; determining, for each model instance among a plurality of model instances, a cache hit rate corresponding to the model instance based on a first data index and the at least one first data item, where each model instance caches a plurality of historical data items and respective encoding results of the plurality of historical data items, the cache hit rate corresponding to each model instance indicates a proportion, in the at least one first data item, of an intersection between the plurality of historical data items cached by the model instance and the at least one first data item, and where the first data index includes: a plurality of second data items, where the plurality of second data items are determined by performing deduplication processing based on the plurality of historical data items cached by the plurality of model instances; and a data identifier corresponding to each second data item among the plurality of second data items, where the data identifier corresponding to each second data item includes a plurality of sub- identifiers respectively corresponding to the plurality of model instances, each sub-identifier indicating whether the model instance corresponding to the sub-identifier caches the second data item; determining a target model instance from the plurality of model instances based on the cache hit rate corresponding to each model instance; and scheduling the model inference request to the target model instance to perform inference.

According to another aspect of the present disclosure, an electronic device is provided, including: at least one processor; and a memory communicatively connected to the at least one processor, where the memory storing one or more programs configured to be executed by the one or more processors, the one or more programs including instructions for: determining, based on a model inference request to be scheduled, at least one first data item to be encoded; determining, for each model instance among a plurality of model instances, a cache hit rate corresponding to the model instance based on a first data index and the at least one first data item, wherein each model instance caches a plurality of historical data items and respective encoding results of the plurality of historical data items, and wherein the cache hit rate corresponding to each model instance among the plurality of model instances indicates a proportion, in the at least one first data item, of an intersection between the plurality of historical data items cached by the model instance and the at least one first data item, and wherein the first data index includes: a plurality of second data items, wherein the plurality of second data items are determined by performing deduplication processing based on a plurality of historical data items cached by the plurality of model instances; and a data identifier corresponding to each second data item among the plurality of second data items, wherein the data identifier corresponding to each second data item includes a plurality of sub-identifiers respectively corresponding to the plurality of model instances, and wherein each sub-identifier of the plurality of sub-identifiers indicating whether the model instance corresponding to the sub-identifier caches the second data item; determining a target model instance from the plurality of model instances based on the cache hit rate corresponding to each model instance among the plurality of model instances; and scheduling the model inference request to the target model instance to perform inference.

According to another aspect of the present disclosure, a non-transitory computer-readable storage medium storing computer instructions is provided, where the computer instructions are used to cause a computer to: determine, based on a model inference request to be scheduled, at least one first data item to be encoded; determine, for each model instance among a plurality of model instances, a cache hit rate corresponding to the model instance based on a first data index and the at least one first data item, wherein each model instance caches a plurality of historical data items and respective encoding results of the plurality of historical data items, and wherein the cache hit rate corresponding to each model instance among the plurality of model instances indicates a proportion, in the at least one first data item, of an intersection between the plurality of historical data items cached by the model instance and the at least one first data item, and wherein the first data index includes: a plurality of second data items, wherein the plurality of second data items are determined by performing deduplication processing based on a plurality of historical data items cached by the plurality of model instances; and a data identifier corresponding to each second data item among the plurality of second data items, wherein the data identifier corresponding to each second data item includes a plurality of sub-identifiers respectively corresponding to the plurality of model instances, and wherein each sub-identifier of the plurality of sub-identifiers indicating whether the model instance corresponding to the sub-identifier caches the second data item; determine a target model instance from the plurality of model instances based on the cache hit rate corresponding to each model instance among the plurality of model instances; and scheduling the model inference request to the target model instance to perform inference.

According to one or more embodiments of the present disclosure, the cache hit rate of a request to be processed in a plurality of model instances can be calculated more efficiently, hardware resources can be saved, and more efficient scheduling of model inference requests can be achieved.

It should be understood that the content described in this section is not intended to identify critical or important features of the embodiments of the present disclosure, and is not intended to limit the scope of the present disclosure. Other features of the present disclosure will be readily understood with reference to the following description.

### BRIEF DESCRIPTIONS OF THE DRAWINGS

The accompanying drawings show example embodiments and form a part of the specification, and are used to explain example implementations of the embodiments together with the written description of the specification. The embodiments shown are merely for illustrative purposes and do not limit the scope of the claims. Throughout the accompanying drawings, the same reference numerals denote similar but not necessarily same elements.

FIG. 1 illustrates a schematic diagram of an example system in which various methods described herein may be implemented according to an example embodiment of the present disclosure;

FIG. 2 illustrates a flowchart of a scheduling method for a model inference request according to an example embodiment of the present disclosure;

FIG. 3 illustrates a schematic diagram of a model inference process according to an example embodiment of the present disclosure;

FIG. 4 illustrates a structural block diagram of a scheduling apparatus for a model inference request according to an example embodiment of the present disclosure; and

FIG. 5 illustrates a structural block diagram of an example electronic device that can be used to implement embodiments of the present disclosure.

### DETAILED DESCRIPTION

Example embodiments of the present disclosure are described below in conjunction with the accompanying drawings, where various details of the embodiments of the present disclosure are included to facilitate understanding, and should only be considered as example. Therefore, those of ordinary skill in the art should be aware that various changes and modifications can be made to the embodiments described here, without departing from the scope of the present disclosure. Likewise, for clarity and conciseness, the description of well-known functions and structures is omitted in the following description.

In the present disclosure, unless otherwise stated, the terms "first", "second", etc., used to describe various elements are not intended to limit the positional, temporal, or importance relationship of these elements, but rather only to distinguish one component from another. In some examples, a first element and a second element may refer to a same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term "and/or" used in the present disclosure encompasses any of and all possible combinations of the listed terms.

The embodiments of the present disclosure will be described below in detail with reference to the accompanying drawings.

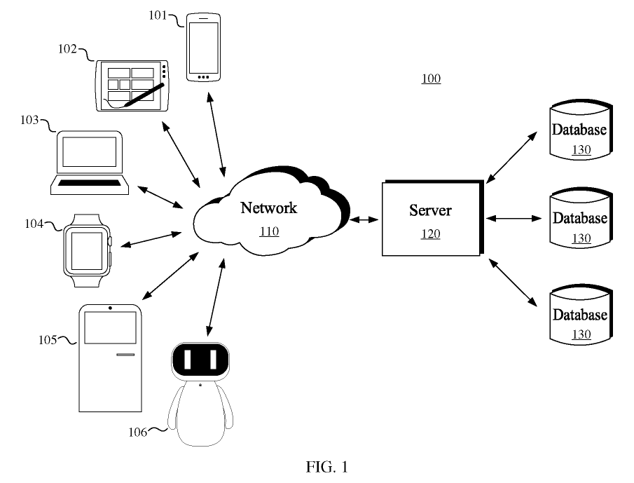

FIG. 1 is a schematic diagram of an example system 100 in which various methods and apparatuses described herein can be implemented according to an embodiment of the present disclosure. Referring to FIG. 1, the system 100 includes one or more client devices 101, 102, 103, 104, 105, and 106, a server 120, and one or more communication networks 110 that couple the one or more client devices to the server 120. The client devices 101, 102, 103, 104, 105, and 106 may be configured to execute one or more applications.

In an embodiment of the present disclosure, the server 120 can run one or more services or software applications that enable a scheduling method for a model inference request to be performed.

In some embodiments, the server 120 may further provide other services or software applications that may include a non-virtual environment and a virtual environment. In some embodiments, these services may be provided as web-based services or cloud services, for example, provided to a user of the client devices 101, 102, 103, 104, 105, and/or 106 in a software- as-a-service (SaaS) model.

In the configuration shown in FIG. 1, the server 120 may include one or more components that implement functions performed by the server 120. These components may include software components, hardware components, or a combination thereof that can be executed by one or more processors. The user operating the client devices 101, 102, 103, 104, 105, and/or 106 may sequentially use one or more client applications to interact with the server 120, to use the services provided by these components. It should be understood that various different system configurations are possible, and may be different from that of the system 100. Therefore, FIG. 1 is an example of the system for implementing various methods described herein, and is not intended to be limiting.

The user may use the client devices 101, 102, 103, 104, 105, and/or 106 to send a model inference request. The client device may provide an interface that enables the user of the client device to interact with the client device. The client device may further output information to the user via the interface. Although FIG. 1 shows only six client devices, those skilled in the art will understand that any number of client devices can be supported in the present disclosure.

The client devices 101, 102, 103, 104, 105, and/or 106 may include various types of computer devices, for example, a portable handheld device, a general-purpose computer (for example, a personal computer and a laptop computer), a workstation computer, a wearable device, a smart screen device, a self-service terminal device, a service robot, a gaming system, a thin client, various messaging devices, and a sensor or other sensing devices. These computer devices may run various types and versions of software application programs and operating systems, such as MICROSOFT Windows, APPLE iOS, a UNIX-like operating system, and a Linux or Linux-like operating system (e.g., GOOGLE Chrome OS); or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various applications, such as various Internet- related applications, communication applications (e.g., email applications), and short message service (SMS) applications, and can use various communication protocols.

The network 110 may be any type of network well known to those skilled in the art, and may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a blockchain network, a public switched telephone network (PSTN), an infrared network, a wireless network (e.g., Bluetooth or WIFI), and/or any combination of these and/or other networks.

The server 120 may include one or more general-purpose computers, a dedicated server computer (e.g., a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures related to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any one of the above-mentioned operating systems and any commercially available server operating system. The server 120 can also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from users of the client devices 101, 102, 103, 104, 105, and 106. The server 120 may further include one or more applications to display the data feeds and/or real-time events via one or more display devices of the client devices 101, 102, 103, 104, 105, and 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be configured to store information such as an audio file and a video file. The databases 130 may reside in various positions. For example, a database used by the server 120 may be locally in the server 120, or may be remote from the server 120 and may communicate with the server 120 via a network-based or dedicated connection. The database 130 may be of different types. In some embodiments, the database used by the server 120 may be, for example, a relational database. One or more of these databases can store, update, and retrieve data from or to the database, in response to a command.

In some embodiments, one or more of the databases 130 may further be used by an application to store application data. The database used by the application may be of different types, for example, may be a key-value repository, an object repository, or a regular repository backed by a file system.

The system 100 of FIG. 1 may be configured and operated in various manners, so that the various methods and apparatuses described according to the present disclosure can be applied.

In the field of large models, as the scale of model parameters and the context length increase, the consumption of computational power by the model inference process increases significantly. In the large model inference process, it is typically necessary to first encode input information, and then obtain a final inference result based on the encoding result. For example, in autoregressive inference of a Transformer model, it is necessary to convert original input information into an initial encoding result to obtain a plurality of minimum data units that can be processed by the model, i.e., a plurality of input tokens, and then perform attention mechanism- based encoding calculation based on the plurality of input tokens to obtain key vectors (Key) and value vectors (Value) corresponding to the input tokens. This process corresponds to a prefill process of large model inference. Since Key and Value are necessary intermediate results in attention calculation, by caching the Key and Value corresponding to the input tokens, the cached Key/Value cache results can be reused during the process of the model processing a large amount of input information, thereby avoiding redundant calculations, and improving the efficiency of model inference while saving hardware resources. Taking a scenario of implementing multi-turn human-machine dialogue based on a large model as an example, as the number of dialogue turns increases, the proportion of redundant calculation of historical tokens continues to increase, directly leading to redundant consumption of computational power.

In practical application scenarios, in order to improve the efficiency of model inference and support large-scale concurrent requests, a plurality of model instances are typically deployed to process model inference requests of users. In this case, each model instance caches, during an inference process, intermediate encoding results of inference requests processed by the model instance itself. In related technologies, a cache information index for each model instance is typically maintained separately for different model instances. This approach occupies substantial hardware resources, leading to long calculation time when it is necessary to schedule, based on the cache information of the model instance, a model inference request to be processed, thereby affecting the efficiency of model inference.

Based on this, the present disclosure provides a scheduling method for a model inference request, which constructs a unified data index for encoding results of historical data items cached by a plurality of model instances, and performs deduplication for duplicate data items and manages them using data identifiers. This is beneficial for more efficiently calculating a cache hit rate of each model instance, and determining a target instance for request scheduling based on this, so as to save hardware resources and schedule model inference requests among a plurality of model instances more efficiently and accurately.

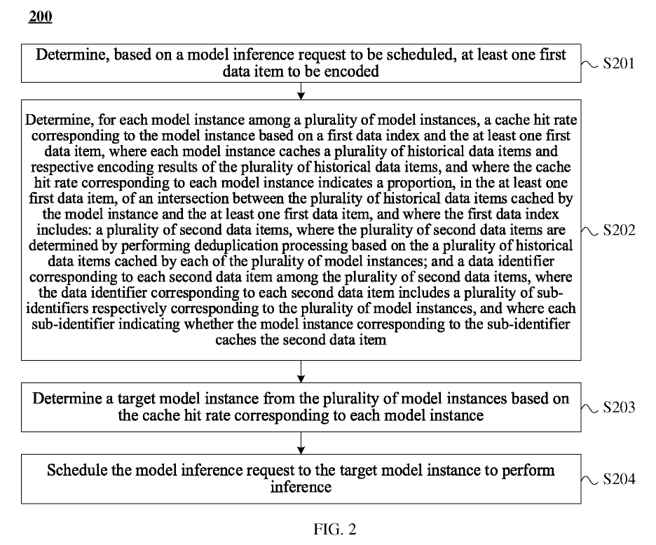

FIG. 2 illustrates a flowchart of a scheduling method 200 for a model inference request according to an example embodiment of the present disclosure. As shown in FIG. 2, the method 200 includes the following steps.

Step S201: Determine, based on a model inference request to be scheduled, at least one first data item to be encoded.

Step S202: Determine, for each model instance among a plurality of model instances, a cache hit rate corresponding to the model instance based on a first data index and the at least one first data item, where each model instance caches a plurality of historical data items and respective encoding results of the plurality of historical data items, and where the cache hit rate corresponding to each model instance indicates a proportion, in the at least one first data item, of an intersection between the plurality of historical data items cached by the model instance and the at least one first data item, and where the first data index includes: a plurality of second data items, where the plurality of second data items are determined by performing deduplication processing based on a plurality of historical data items cached by the plurality of model instances; and a data identifier corresponding to each second data item among the plurality of second data items, where the data identifier corresponding to each second data item includes a plurality of sub-identifiers respectively corresponding to the plurality of model instances, and where each sub-identifier indicating whether the model instance corresponding to the sub-identifier caches the second data item.

Step S203: Determine a target model instance from the plurality of model instances based on the cache hit rate corresponding to each model instance.

Step S204: Schedule the model inference request to the target model instance to perform inference.

By applying the first data index described in step S202 to a management process for a plurality of model instances to maintain cache index information of each model instance, a unified data index can be constructed for historical data items cached by the plurality of model instances and encoding results thereof, deduplication can be performed for duplicate data items, and management can be performed using data identifiers, thereby saving storage resources. Further, by applying the aforementioned method 200 to schedule model inference requests, a cache hit rate of a model inference request to be processed in each model instance can be calculated more efficiently, and a target model instance corresponding to the request to be processed can be determined based on this, thereby improving the efficiency of model inference.

It can be understood that, since intermediate encoding results of historical requests cached by various model instances are different, when a new request to be processed is received, the cache hit rate corresponding to each model instance can be determined by being aware of historical data items of each model instance maintained in the first data index. Specifically, duplication rate calculation may be performed based on the plurality of second data items and the at least one first data item to be encoded, and then the cache hit rate corresponding to each model instance may be determined based on data identifiers corresponding to hit results of the at least one first data item among the plurality of second data items, without performing the duplication rate calculation for data hits separately for a cache of each model instance, thereby reducing occupation of hardware resources and improving the efficiency of request scheduling.

In some examples, the model inference request may be in various forms. For example, it may be a text processing request including natural language text, or it may also be a model inference request including data of various modalities, such as pictures and voices. As described above, when a model is used to perform processing based on input data, the input data needs to be first converted into an initial encoding result that the model can understand and process. In this case, the at least one first data item may be initial encoding results of different forms corresponding to different types of input data, for example, a text semantic embedding representation corresponding to a text tokenization result (token). As long as intermediate results of a model inference process can be cached by maintaining data items and encoding results corresponding to the data items, the present disclosure does not limit specific forms of the first data item and the historical data items.

According to some embodiments, the plurality of historical data items cached by each model instance are determined based on text characters, the first data index is an index tree composed of the plurality of second data items, and a text character sequence corresponding to a path from a root node to a leaf node in the index tree is determined based on historical model inference requests processed by the plurality of model instances. When the method 200 is applied to an inference service of a large language model, tokenization is performed on a model inference request in natural language form, and a cache index is constructed based on a tokenization result and encoding results corresponding to the tokenization result. By using nodes of a tree structure to store text characters (tokenization results), path in the tree can be used to indicate the text character sequence included in the model inference request, and the cache hit rate can be calculated more efficiently by querying path in the tree structure starting from a root node.

In one example, when a historical request processed by a model instance includes a text sequence A-B-C-D, A is used as a root node of a cache index tree, and then nodes corresponding to B, C, and D respectively are stored sequentially based on a parent-child node connection relationship. In this case, when a new request to be processed includes a text sequence A-B-C-E, A is used as the root node to query a branch path in the index tree, thereby efficiently and conveniently determining that the new request to be processed can hit nodes A, B, and C in the index tree. In one example, information stored in each node may be a character or word in text form, or may be a text semantic embedding representation. When the aforementioned historical request including the text sequence A-B-C-D is processed by a model instance 01, data identifiers of four nodes corresponding to A, B, C, and D include a sub-identifier indicating the model instance 01. In a scheduling process for a model inference request, cache hit rates of different model instances are determined based on the data identifiers of the nodes, thereby achieving efficient and accurate request scheduling.

In some examples, in step S203, a model instance with the highest cache hit rate is used as the target model instance, so as to fully utilize intermediate encoding results cached by the model instance to accelerate execution of the model inference request and improve the utilization of hardware resources.

According to some embodiments, the method 200 further includes: dividing the plurality of model instances into a plurality of model instance groups; and for each model instance group among the plurality of model instance groups, determining, from the plurality of second data items based on the data identifier corresponding to each second data item in the first data index, at least one third data item cached by at least one model instance in the model instance group; and constructing, based on the at least one third data item and the data identifier corresponding to each third data item, a second data index corresponding to the model instance group, where in step S202, the determining, for each model instance among the plurality of model instances, the cache hit rate corresponding to the model instance based on the first data index and the at least one first data item includes: determining, for each model instance group among the plurality of model instance groups, the cache hit rate corresponding to each model instance in the model instance group using a cache-aware unit corresponding to the model instance group based on the second data index corresponding to the model instance group and the at least one first data item.

Thus, a cache-aware routing service (i.e., a service for querying cache information of model instances and calculating hit rates of a current request in caches of the model instances) can be horizontally sharded, and a plurality of model instances are allocated to different shards (i.e., divided into a plurality of model instance groups) for separate management, thereby improving efficiency and stability of cache-aware routing service. By extracting instance cache index information by querying an identifier of a data item (i.e., a node of a cache information index of a model instance) in a process of constructing shards of the cache-aware routing service (configuring a plurality of cache-aware units), sharding of the cache index can be implemented simply and efficiently, thereby supporting distributed deployment of the cache-aware routing service.

In some examples, the number of model instance groups and specific rules for dividing the plurality of model instances into the plurality of model instance groups is determined according to actual requirements. For example, the plurality of model instances may be grouped evenly, or grouping is performed based on request throughput or request processing capability of each model instance, so as to achieve load balancing among the plurality of model instance groups (i.e., the plurality of cache-aware units).

According to some embodiments, the cache-aware unit corresponding to each model instance group includes a master service module and a backup service module, and the second data index corresponding to each model instance group is stored in the master service module of the cache-aware unit corresponding to the model instance group, the method 200 further including: for each model instance group of the plurality of model instance groups, backing up the second data index corresponding to the model instance group to the backup service module of the cache- aware unit corresponding to the model instance group; and determining, in response to determining that a faulty master service module exists in cache-aware units, the cache hit rate corresponding to each model instance in the model instance group corresponding to the faulty master service module using the backup service module corresponding to the faulty master service module. Thus, a master-standby backup mechanism can be set for each cache-aware unit to improve service stability.

In some examples, the second data index of the model instance group maintained by the master service module is asynchronously updated to the backup service module, so as the backup service module can accurately determine the cache hit rate of each model instance corresponding to the request to be processed, thereby achieving accurate request scheduling based on this. By first dividing the plurality of model instances into a plurality of groups, and then maintaining the cache index and performing backup of the cache-aware routing service in units of model instance groups, the data traffic pressure of master-standby asynchronous backup can be reduced, the backup response speed upon failure can be improved, thereby improving robustness of the cache- aware routing service.

According to some embodiments, the method 200 further includes: in response to receiving an instruction to add a cache-aware unit, where the instruction indicates at least one first model instance to be included in a new model instance group corresponding to a new cache-aware unit, determining, based on the data identifier corresponding to each second data item in at least one second data index corresponding to at least one model instance group to which the at least one first model instance belongs, at least one fourth data item cached by the at least one first model instance; and constructing, based on the at least one fourth data item and the data identifier corresponding to each fourth data item, a second data index corresponding to the new model instance group. Thus, horizontal scaling of the cache-aware unit can be implemented during operation of the model inference service, so as to adapt to changes in load requirements of the model inference service and improve service stability.

In some examples, when the cache-aware routing service is divided into a plurality of cache-aware units and deployed in a distributed manner, load monitoring and dynamic scaling management for the plurality of cache-aware units are implemented by an upper-layer host. When a new cache-aware unit is configured in the cache-aware routing service and at least one first model instance to be managed by the new cache-aware unit is determined, data items corresponding to the first model instances are extracted based on data identifiers corresponding to the first model instances in the second data index maintained by an original cache-aware unit, so as to initialize cache index information to be managed and maintained by the new cache-aware unit, thereby implementing a convenient scaling operation.

According to some embodiments, the method 200 further includes: determining current occupancy information of each model instance among the plurality of model instances, where in step S203, the determining the target model instance from the plurality of model instances based on the cache hit rate corresponding to each model instance includes: determining the target model instance from the plurality of model instances based on the cache hit rate corresponding to each model instance and the current occupancy information of each model instance. By further combining the current occupancy information of the model instance to determine the target model instance for the model inference request to be processed, the accuracy of request scheduling can be further improved, so that the request to be processed can be processed more efficiently, load balancing among the plurality of model instances is achieved, and the efficiency of model inference is improved.

According to some embodiments, the current occupancy information includes a load rate, and the determining the target model instance from the plurality of model instances based on the cache hit rate corresponding to each model instance and the current occupancy information of each model instance includes: determining, for each model instance among the plurality of model instances, a score of the model instance based on a weighted sum of the cache hit rate corresponding to the model instance and an opposite value of the load rate of the model instance; and determining the target model instance based on the score of each model instance. Thus, linear weighted calculation can be performed based on the cache hit rate and the load rate of the model instance to obtain a score of each model instance, thereby achieving simpler and more accurate request scheduling based on this and improving the efficiency of model inference.

In some examples, respective calculation weights of the cache hit rate corresponding to each model instance and the load rate of each model instance are flexibly adjusted according to requirements, so that a scheduling result of the request to be processed better meets the requirements of an actual application scenario.

According to some embodiments, the method 200 further includes: determining description information of each model instance among the plurality of model instances, the description information of each model instance indicating request processing capability of the model instance, where the determining the target model instance from the plurality of model instances based on the cache hit rate corresponding to each model instance and the current occupancy information of each model instance includes: determining the target model instance from the plurality of model instances based on the cache hit rate corresponding to each model instance, the current occupancy information of each model instance, and the description information of each model instance. By further combining the request processing capability of the model instance to determine the target model instance for the model inference request to be processed, the accuracy of request scheduling can be further improved, so that the request to be processed can be processed more efficiently, load balancing among the plurality of model instances is achieved, and the efficiency of model inference is improved.

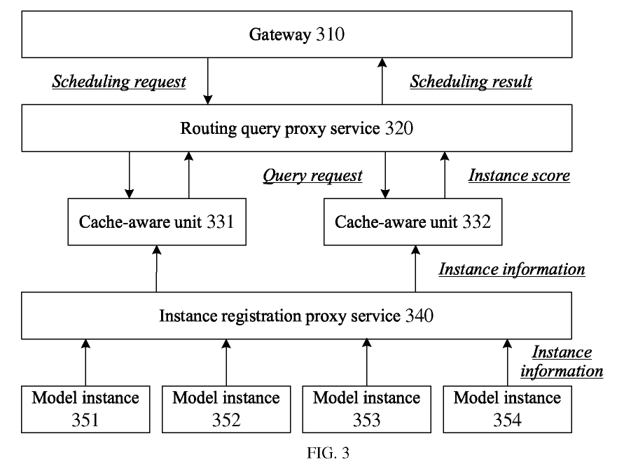

FIG. 3 illustrates a schematic diagram of a model inference process according to an example embodiment of the present disclosure. Referring to FIG. 3, in this example, a gateway 310 is used to connect a receiving port of a model inference request and a plurality of model instances capable of actually processing the model inference request, so as to schedule the model inference request sent by a user to a model instance for processing. After the gateway 310 receives the model inference request, it sends a request for querying a target model instance to a routing query proxy service 320, and the routing query proxy service 320 sends a query request to a plurality of shards (e.g., a cache-aware unit 331 and a cache-aware unit 332) of a cache-aware routing service. On this basis, the cache-aware unit 331 calculates based on cache index information of a model instance 351 and a model instance 352 managed by the unit, cache hit rates corresponding to the model instance 351 and the model instance 352 respectively, and at the same time, the cache-aware unit 332 calculates based on cache index information of a model instance 353 and a model instance 354 managed by the unit, cache hit rates corresponding to the model instance 353 and the model instance 354 respectively. Each cache-aware unit returns an instance score of each model instance to the routing query proxy service based on the respective cache hit rate corresponding to each model instance, so that the routing query proxy service 320 can determine a target model instance based on the instance score of each model instance and return a query result to the upper-layer gateway 310, and the gateway 310 schedules the model inference request to the target model instance based on the query result to perform inference. In this example, each cache-aware unit does not have direct knowledge of information of the plurality of underlying model instances. In order to manage a mapping relationship between the cache-aware units and the model instances (i.e., allocating the plurality of model instances to the plurality of cache-aware units for management), an instance registration proxy service 340 is used to register information of each model instance and maintain the mapping relationship between the cache-aware units and the model instances, so that each cache-aware unit can obtain information of the underlying model instances that the cache-aware unit is responsible for managing and maintain a cache index of the model instance. By applying the aforementioned method to schedule model inference requests, a cache hit rate of a model inference request to be processed in each model instance can be calculated more efficiently, and a target model instance corresponding to the request to be processed can be determined based on this, thereby improving the efficiency of model inference.

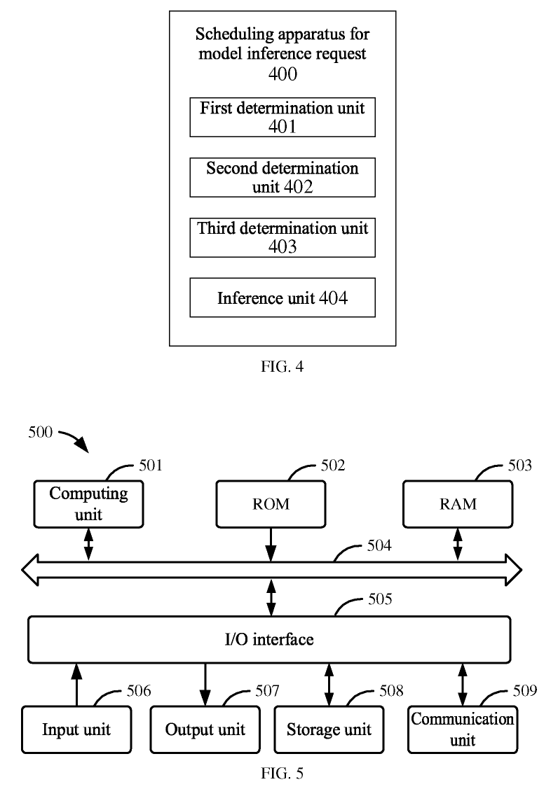

According to an aspect of the present disclosure, a scheduling apparatus for a model inference request is further provided. FIG. 4 illustrates a structural block diagram of a scheduling apparatus 400 for a model inference request according to an example embodiment of the present disclosure. As shown in FIG. 4, the apparatus 400 includes:

a first determination unit 401 configured to determine, based on a model inference request to be scheduled, at least one first data item to be encoded;

a second determination unit 402 configured to determine, for each model instance among

a plurality of model instances, a cache hit rate corresponding to the model instance based on a first data index and the at least one first data item, where each model instance caches a plurality of historical data items and respective encoding results of the plurality of historical data items, the cache hit rate corresponding to each model instance indicates a proportion, in the at least one first data item, of an intersection between the plurality of historical data items cached by the model instance and the at least one first data item, and where the first data index includes: a plurality of second data items, where the plurality of second data items are determined by performing deduplication processing based on the plurality of historical data items cached by each of the plurality of model instances; and a data identifier corresponding to each second data item among the plurality of second data items, where the data identifier corresponding to each second data item includes a plurality of sub-identifiers respectively corresponding to the plurality of model instances, each sub-identifier indicating whether the model instance corresponding to the sub-identifier caches the second data item;

a third determination unit 403 configured to determine a target model instance from the plurality of model instances based on the cache hit rate corresponding to each model instance; and

an inference unit 404 configured to schedule the model inference request to the target model instance to perform inference.

According to some embodiments, the apparatus 400 further includes: a division unit configured to divide the plurality of model instances into a plurality of model instance groups; a fourth determination unit configured to, for each model instance group among the plurality of model instance groups, determine, from the plurality of second data items based on the data identifier corresponding to each second data item in the first data index, at least one third data item cached by at least one model instance in the model instance group; and a first construction unit configured to construct, based on the at least one third data item and the data identifier corresponding to each third data item, a second data index corresponding to the model instance group, where the second determination unit 402 is configured to: determine, for each model instance group among the plurality of model instance groups, the cache hit rate corresponding to each model instance in the model instance group using a cache-aware unit corresponding to the model instance group based on the second data index corresponding to the model instance group and the at least one first data item.

According to some embodiments, the cache-aware unit corresponding to each model instance group includes a master service module and a backup service module, and the second data index corresponding to each model instance group is stored in the master service module of the cache-aware unit corresponding to the model instance group, the apparatus 400 further including: a backup unit configured to back up the second data index corresponding to each model instance group to the backup service module of the cache-aware unit corresponding to the model instance group; and the second determining unit 402 is further configured to determine, in response to determining that a faulty master service module exists in the cache-aware unit, the cache hit rate corresponding to each model instance in the model instance group corresponding to the faulty master service module using the backup service module corresponding to the faulty master service module.

According to some embodiments, the apparatus 400 further includes: a fifth determination unit configured to: in response to receiving an instruction to add a cache-aware unit, where the instruction indicates at least one first model instance to be included in a new model instance group corresponding to a new cache-aware unit, determine, based on the data identifier corresponding to each second data item in the second data index corresponding to each of at least one model instance group to which the at least one first model instance belongs, at least one fourth data item cached by the at least one first model instance; and a second construction unit configured to construct, based on the at least one fourth data item and the data identifier corresponding to each fourth data item, a second data index corresponding to the new model instance group.

According to some embodiments, the apparatus 400 further includes: a sixth determination unit configured to determine current occupancy information of each model instance among the plurality of model instances, where the third determination unit 403 is configured to: determine the target model instance from the plurality of model instances based on the cache hit rate corresponding to each model instance and the current occupancy information of each model instance.

According to some embodiments, the current occupancy information includes a load rate, and the third determination unit 403 includes: a first determination sub-unit configured to determine, for each model instance among the plurality of model instances, a score of the model instance based on a weighted sum of the cache hit rate corresponding to the model instance and an opposite value of the load rate of the model instance; and a second determination sub-unit configured to determine the target model instance based on the score of each model instance.

According to some embodiments, the apparatus 400 further includes: a seventh determination unit configured to determine description information of each model instance among the plurality of model instances, the description information of each model instance indicating request processing capability of the model instance, where the third determination unit 403 is configured to: determine the target model instance from the plurality of model instances based on the cache hit rate corresponding to each model instance, the current occupancy information of each model instance, and the description information of each model instance.

According to some embodiments, the plurality of historical data items cached by each model instance are determined based on text characters, the first data index is an index tree composed of the plurality of second data items, and a text character sequence corresponding to a path from a root node to a leaf node in the index tree is determined based on historical model inference requests processed by the plurality of model instances.

According to another aspect of the present disclosure, an electronic device is further provided, including: at least one processor; and a memory communicatively connected to the at least one processor, where the memory stores instructions executable by the at least one processor, the instructions, when executed by the at least one processor, causing the at least one processor to perform the scheduling method for a model inference request described above.

According to another aspect of the present disclosure, a non-transitory computer-readable storage medium storing computer instructions is further provided, where the computer instructions are used to cause a computer to perform the scheduling method for a model inference request described above.

According to another aspect of the present disclosure, a computer program product is further provided, including a computer program, where the computer program, when executed by a processor, causes the scheduling method for a model inference request described above to be implemented.

Referring to FIG. 5, a structural block diagram of an electronic device 500 will be described below, which can serve as a server or a client of the present disclosure and is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the present disclosure described and/or required herein.

As shown in FIG. 5, the device 500 includes a computing unit 501. The computing unit may perform various appropriate actions and processing according to a computer program stored in a read-only memory (ROM) 502 or a computer program loaded from a storage unit 508 into a random access memory (RAM) 503. Various programs and data required for the operation of the device 500 may also be stored in RAM 503. The computing unit 501, the ROM 502, and the RAM 503 are connected to each other through a bus 504. An input/output (I/O) interface 505 is also connected to the bus 504.

A plurality of components in the device 500 are connected to the I/O interface 505, including: an input unit 506, an output unit 507, the storage unit 508, and a communication unit 509. The input unit 506 may be any type of device capable of inputting information to the device 500. The input unit 506 may receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 507 may be any type of device capable of presenting information, and may include, but is not limited to, a display, a speaker, a video/audio output terminal, a vibrator, and/or a printer. The storage unit 508 may include, but is not limited to, a magnetic disk and an optical disk. The communications unit 509 allows the device 500 to exchange information/data with other devices via a computer network such as the Internet and/or various telecommunications networks, and may include, but is not limited to, a modem, a network interface card, an infrared communication device, a wireless communication transceiver and/or a chipset, e.g., a BluetoothTMl device, an 802.11 device, a WiFi device, a WiMax device, a cellular communication device, and/or the like.

The computing unit 501 may be various general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units on which machine learning model algorithms run, a digital signal processor (DSP), and any appropriate processor, controller, microcontroller, etc. The computing unit 501 performs the various methods and processing described above, for example, the scheduling method for a model inference request. For example, in some embodiments, the scheduling method for a model inference request may be implemented as a computer software program, which is tangibly contained in a machine-readable medium, such as the storage unit 508. In some embodiments, part or all of the computer program may be loaded and/or installed onto the device 500 via the ROM 502 and/or the communication unit 509. When the computer program is loaded to the RAM 503 and executed by the computing unit 501, one or more steps of the scheduling method for a model inference request described above may be performed. Alternatively, in other embodiments, the computing unit 501 may be configured, by any other suitable means (for example, by means of firmware), to perform the scheduling method for a model inference request.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logic device (CPLD), computer hardware, firmware, software, and/or a combination thereof. These various implementations may include: implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input means, and at least one output means, and transmit data and instructions to the storage system, the at least one input apparatus, and the at least one output means.

Program codes used to implement the method of the present disclosure can be written in any combination of one or more programming languages. The program code may be provided for a processor or a controller of a general-purpose computer, a special-purpose computer, or other programmable data processing apparatuses, such that when the program code is executed by the processor or the controller, the functions/operations specified in the flowcharts and/or block diagrams are implemented. The program code may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine- readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (e.g., a cathode-ray tube (CRT) or a liquid crystal display (LCD) monitor) configured to display information to the user; and a keyboard and a pointing means (e.g., a mouse or a trackball) through which the user can provide an input to the computer. Other categories of apparatuses can also be used to provide interaction with the user; for example, feedback provided to the user can be any form of sensory feedback (e.g., visual feedback, auditory feedback, or tactile feedback); and an input from the user can be received in any form (including an acoustic input, a voice input, or a tactile input).

The systems and technologies described herein can be implemented in a computing system including a backend component (for example, as a data server), in a computing system including a middleware component (for example, an application server), in a computing system including a frontend component (for example, a user computer with a graphical user interface or a web browser through which the user can interact with the implementation of the systems and technologies described herein), or in a computing system including any combination of the backend component, the middleware component, and the frontend component. The components of the system can be connected to each other through digital data communication (for example, a communication network) in any form or medium. Examples of the communication network include: a local area network (LAN), a wide area network (WAN), the Internet, and a blockchain network.

A computer system may include a client and a server. The client and the server are generally far away from each other and usually interact through a communication network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, successively, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely embodiments or examples, and the scope of the present disclosure is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A scheduling method for a model inference request, comprising:
determining, based on a model inference request to be scheduled, at least one first data item to be encoded;
determining, for each model instance among a plurality of model instances, a cache hit rate corresponding to the model instance based on a first data index and the at least one first data item, wherein each model instance caches a plurality of historical data items and respective encoding results of the plurality of historical data items, and wherein the cache hit rate corresponding to each model instance among the plurality of model instances indicates a proportion, in the at least
one first data item, of an intersection between the plurality of historical data items cached by the model instance and the at least one first data item, and wherein the first data index includes:a plurality of second data items, wherein the plurality of second data items are determined by performing deduplication processing based on a plurality of historical data items cached by the plurality of model instances; anda data identifier corresponding to each second data item among the plurality of second data items, wherein the data identifier corresponding to each second data item includes a plurality of sub-identifiers respectively corresponding to the plurality of model instances, and wherein each sub-identifier of the plurality of sub-identifiers indicating whether the model instance corresponding to the sub-identifier caches the second data item;
determining a target model instance from the plurality of model instances based on the cache hit rate corresponding to each model instance among the plurality of model instances; and
scheduling the model inference request to the target model instance to perform inference.

2. The method according to claim 1, further comprising:
dividing the plurality of model instances into a plurality of model instance groups; and
for each model instance group among the plurality of model instance groups,determining, from the plurality of second data items based on the data identifier corresponding to each second data item in the first data index, at least one third data item cached by at least one model instance in the model instance group; andconstructing, based on the at least one third data item and a data identifier corresponding
to each third data item of the at least one third data item, a second data index corresponding to the model instance group,wherein the determining, for each model instance among the plurality of model instances, the cache hit rate corresponding to the model instance based on the first data index and the at least one
first data item comprises:determining, for each model instance group among the plurality of model instance groups, the cache hit rate corresponding to each model instance in the model instance group using a cache-aware unit corresponding to the model instance group based on the second data index corresponding to the model instance group and the at least one first data item.

3. The method according to claim 2, wherein the cache-aware unit corresponding to each model instance group includes a master service module and a backup service module, and wherein the second data index corresponding to each model instance group is stored in the master service module of the cache-aware unit corresponding to the model instance group, the method further
comprising:for each model instance group of the plurality of model instance groups, backing up the second data index corresponding to the model instance group to the backup service module of the cache-aware unit corresponding to the model instance group; anddetermining, in response to determining that a faulty master service module exists in cache-
aware units, the cache hit rate corresponding to each model instance in the model instance group corresponding to the faulty master service module using the backup service module corresponding to the faulty master service module.

4. The method according to claim 2, further comprising:
in response to receiving an instruction to add a cache-aware unit, wherein the instruction indicates at least one first model instance to be included in a new model instance group corresponding to a new cache-aware unit,determining, based on the data identifier corresponding to each second data item in at least one second data index corresponding to at least one model instance group to which the at
least one first model instance belongs, at least one fourth data item cached by the at least one first 23
model instance; andconstructing, based on the at least one fourth data item and the data identifier corresponding to each fourth data item of the at least one fourth data item, a second data index corresponding to the new model instance group.

5. The method according to claim 1, further comprising:
determining current occupancy information of each model instance among the plurality of model instances,
wherein the determining the target model instance from the plurality of model instances based
on the cache hit rate corresponding to each model instance among the plurality of model instances includes:determining the target model instance from the plurality of model instances based on the cache hit rate corresponding to each model instance among the plurality of model instances and the current occupancy information of each model instance among the plurality of model instances.

6. The method according to claim 5, wherein the current occupancy information includes a load rate, and the determining the target model instance from the plurality of model instances based on the cache hit rate corresponding to each model instance among the plurality of model instances and the current occupancy information of each model instance among the plurality of model
instances comprises:determining, for each model instance among the plurality of model instances, a score of the model instance based on a weighted sum of the cache hit rate corresponding to the model instance and an opposite value of the load rate of the model instance; anddetermining the target model instance based on the score of each model instance among the
plurality of model instances.

7. The method according to claim 5, further comprising:
determining description information of each model instance among the plurality of model instances, the description information of each model instance indicating request processing
capability of the model instance,
wherein the determining the target model instance from the plurality of model instances based on the cache hit rate corresponding to each model instance among the plurality of model instances and the current occupancy information of each model instance among the plurality of model instances comprises:
determining the target model instance from the plurality of model instances based on the cache hit rate corresponding to each model instance among the plurality of model instances, the current occupancy information of each model instance among the plurality of model instances, and
the description information of each model instance among the plurality of model instances.

8. The method according to claim 1, wherein the plurality of historical data items cached by each model instance among the plurality of model instances are determined based on text characters, and wherein the first data index is an index tree composed of the plurality of second data items, and wherein a text character sequence corresponding to a path from a root node to a leaf node in the index tree is determined based on historical model inference requests processed
by the plurality of model instances.

9. An electronic device, comprising:
at least one processor; and
a memory communicatively connected to the at least one processor; wherein
the memory storing one or more programs configured to be executed by the one or more processors, the one or more programs including instructions for:
determining, based on a model inference request to be scheduled, at least one first data item to be encoded;
determining, for each model instance among a plurality of model instances, a cache hit rate
corresponding to the model instance based on a first data index and the at least one first data item,
wherein each model instance caches a plurality of historical data items and respective encoding results of the plurality of historical data items, and wherein the cache hit rate corresponding to each model instance among the plurality of model instances indicates a proportion, in the at least one first data item, of an intersection between the plurality of historical data items cached by the
model instance and the at least one first data item, and wherein the first data index includes:
a plurality of second data items, wherein the plurality of second data items are determined by performing deduplication processing based on a plurality of historical data items cached by the plurality of model instances; and
a data identifier corresponding to each second data item among the plurality of second
data items, wherein the data identifier corresponding to each second data item includes a plurality of sub-identifiers respectively corresponding to the plurality of model instances, and wherein each sub-identifier of the plurality of sub-identifiers indicating whether the model instance corresponding to the sub-identifier caches the second data item;determining a target model instance from the plurality of model instances based on the cache
hit rate corresponding to each model instance among the plurality of model instances; andscheduling the model inference request to the target model instance to perform inference.

10. The electronic device according to claim 9, wherein the one or more programs further including instructions for:
dividing the plurality of model instances into a plurality of model instance groups; and
for each model instance group among the plurality of model instance groups,determining, from the plurality of second data items based on the data identifier corresponding to each second data item in the first data index, at least one third data item cached by at least one model instance in the model instance group; andconstructing, based on the at least one third data item and a data identifier corresponding to each third data item of the at least one third data item, a second data index corresponding to the model instance group,
wherein the determining, for each model instance among the plurality of model instances, the cache hit rate corresponding to the model instance based on the first data index and the at least one
first data item comprises:determining, for each model instance group among the plurality of model instance groups, the cache hit rate corresponding to each model instance in the model instance group using a cache-aware unit corresponding to the model instance group based on the second data index corresponding to the model instance group and the at least one first data item.

11. The electronic device according to claim 10, wherein the cache-aware unit corresponding to each model instance group includes a master service module and a backup service module, and wherein the second data index corresponding to each model instance group is stored in the master service module of the cache-aware unit corresponding to the model instance group, and wherein
the one or more programs further including instructions for:for each model instance group of the plurality of model instance groups, backing up the second data index corresponding to the model instance group to the backup service module of the cache-aware unit corresponding to the model instance group; anddetermining, in response to determining that a faulty master service module exists in cache-
aware units, the cache hit rate corresponding to each model instance in the model instance group corresponding to the faulty master service module using the backup service module corresponding to the faulty master service module.

12. The electronic device according to claim 10, wherein the one or more programs further
including instructions for:in response to receiving an instruction to add a cache-aware unit, wherein the instruction indicates at least one first model instance to be included in a new model instance group corresponding to a new cache-aware unit,determining, based on the data identifier corresponding to each second data item in at
least one second data index corresponding to at least one model instance group to which the at least one first model instance belongs, at least one fourth data item cached by the at least one first model instance; andconstructing, based on the at least one fourth data item and the data identifier corresponding to each fourth data item of the at least one fourth data item, a second data index
corresponding to the new model instance group.

13. The electronic device according to claim 9, wherein the one or more programs further including instructions for:
determining current occupancy information of each model instance among the plurality of
model instances,
wherein the determining the target model instance from the plurality of model instances based on the cache hit rate corresponding to each model instance among the plurality of model instances includes:
determining the target model instance from the plurality of model instances based on the
cache hit rate corresponding to each model instance among the plurality of model instances and the current occupancy information of each model instance among the plurality of model instances.

14. The electronic device according to claim 13, wherein the current occupancy information includes a load rate, and the determining the target model instance from the plurality of model
instances based on the cache hit rate corresponding to each model instance among the plurality of model instances and the current occupancy information of each model instance among the plurality of model instances comprises:determining, for each model instance among the plurality of model instances, a score of the model instance based on a weighted sum of the cache hit rate corresponding to the model instance
and an opposite value of the load rate of the model instance; anddetermining the target model instance based on the score of each model instance among the plurality of model instances.

15. The electronic device according to claim 13, wherein the one or more programs further
including instructions for:determining description information of each model instance among the plurality of model instances, the description information of each model instance indicating request processing capability of the model instance,wherein the determining the target model instance from the plurality of model instances based
on the cache hit rate corresponding to each model instance among the plurality of model instances and the current occupancy information of each model instance among the plurality of model instances comprises:determining the target model instance from the plurality of model instances based on the cache hit rate corresponding to each model instance among the plurality of model instances, the
current occupancy information of each model instance among the plurality of model instances, and28
the description information of each model instance among the plurality of model instances.

16. The electronic device according to claim 9, wherein the plurality of historical data items cached by each model instance among the plurality of model instances are determined based on
text characters, and wherein the first data index is an index tree composed of the plurality of second data items, and wherein a text character sequence corresponding to a path from a root node to a leaf node in the index tree is determined based on historical model inference requests processed by the plurality of model instances.

17. A non-transient computer-readable storage medium storing one or more programs, the one or more programs comprising instructions, which when executed by one or more processors of an electronic device, cause the electronic device to:
determine, based on a model inference request to be scheduled, at least one first data item to be encoded;
determine, for each model instance among a plurality of model instances, a cache hit rate corresponding to the model instance based on a first data index and the at least one first data item, wherein each model instance caches a plurality of historical data items and respective encoding results of the plurality of historical data items, and wherein the cache hit rate corresponding to each model instance among the plurality of model instances indicates a proportion, in the at least
one first data item, of an intersection between the plurality of historical data items cached by the model instance and the at least one first data item, and wherein the first data index includes:a plurality of second data items, wherein the plurality of second data items are determined by performing deduplication processing based on a plurality of historical data items cached by the plurality of model instances; anda data identifier corresponding to each second data item among the plurality of second data items, wherein the data identifier corresponding to each second data item includes a plurality of sub-identifiers respectively corresponding to the plurality of model instances, and wherein each sub-identifier of the plurality of sub-identifiers indicating whether the model instance corresponding to the sub-identifier caches the second data item;
determine a target model instance from the plurality of model instances based on the cache
hit rate corresponding to each model instance among the plurality of model instances; andschedule the model inference request to the target model instance to perform inference.

18. The non-transient computer-readable storage medium according to claim 17, wherein the
instructions further cause the electronic device to:divide the plurality of model instances into a plurality of model instance groups; andfor each model instance group among the plurality of model instance groups,determine, from the plurality of second data items based on the data identifier corresponding to each second data item in the first data index, at least one third data item cached
by at least one model instance in the model instance group; andconstruct, based on the at least one third data item and a data identifier corresponding to each third data item of the at least one third data item, a second data index corresponding to the model instance group,wherein the determining, for each model instance among the plurality of model instances, the
cache hit rate corresponding to the model instance based on the first data index and the at least one first data item comprises:determining, for each model instance group among the plurality of model instance groups, the cache hit rate corresponding to each model instance in the model instance group using a cache-aware unit corresponding to the model instance group based on the second data index
corresponding to the model instance group and the at least one first data item.

19. The non-transient computer-readable storage medium according to claim 18, wherein the cache-aware unit corresponding to each model instance group includes a master service module and a backup service module, and wherein the second data index corresponding to each model
instance group is stored in the master service module of the cache-aware unit corresponding to the model instance group, and wherein the instructions further cause the electronic device to:for each model instance group of the plurality of model instance groups, back up the second data index corresponding to the model instance group to the backup service module of the cache- aware unit corresponding to the model instance group; anddetermine, in response to determining that a faulty master service module exists in cache- 30
aware units, the cache hit rate corresponding to each model instance in the model instance group corresponding to the faulty master service module using the backup service module corresponding to the faulty master service module.

20. The non-transient computer-readable storage medium according to claim 18, wherein the instructions further cause the electronic device to in response to receiving an instruction to add a cache-aware unit, wherein the instruction indicates at least one first model instance to be included in a new model instance group corresponding to a new cache-aware unit,determine, based on the data identifier corresponding to each second data item in at least one second data index corresponding to at least one model instance group to which the at least one first model instance belongs, at least one fourth data item cached by the at least one first model instance; andconstruct, based on the at least one fourth data item and the data identifier corresponding
to each fourth data item of the at least one fourth data item, a second data index corresponding to the new model instance group.
